(19) United States
(12) Patent Application Publication
(10) Pub. No.: US 2007/0260031 A1
(43) Pub. Date: Nov. 8, 2007

(54) Moisture-hardening adhesives and sealants

(75) Inventors: Matthias Wintermantel, Bergisch Gladbach (DE); Walter Meckel, Dusseldorf (DE)

Correspondence Address: BAYER MATERIAL SCIENCE LLC, 100 BAYER ROAD, PITTSBURGH, PA, 15205, US

(73) Assignee: Bayer MaterialScience AG

(21) Appl. No.: 11/796,421

(22) Filed: Apr. 27, 2007

(30) Foreign Application Priority Data
May 2, 2006 (DE) 102006020605.3

(51) Int. Cl. C08G 18/00

(52) U.S. Cl. 528/44

(57) ABSTRACT

The invention relates to moisture-curable adhesive or sealant compositions comprising a) prepolymers based on aliphatic polyisocyanates and having isocyanate contents of 2 to 20 wt. %, and b) bis(dimethylaminoethyl)ether as catalyst. The compositions exhibit good storability, processability can be adjusted within wide limits and also provide rapid through-hardening.

### CROSS-REFERENCE TO RELATED APPLICATION

This application claims priority under 35 U.S.C. § 119 (a-d) to German application DE 10 2006 020605.3, filed May 2, 2006.

### FIELD OF THE INVENTION

The subject matter of the invention are adhesives and sealants curing under the effect of moisture, having good storability, processability to be adjusted in wide limits and rapid through-hardening.

### BACKGROUND OF THE INVENTION

Moisture-hardening, isocyanate-resistant prepolymers based on aromatic polyisocyanates such as for example TDI and preferably MDI are, dependent on their isocyanate content, used in wide areas of industrial and do-it-yourself (DIY) applications as adhesives, sealants and coating materials.

Examples are the bonding of wood, the production of sandwich constructions composed for example of wood or aluminium sheets with insulation materials such as rock wool, EPS or polyurethane rigid foams to insulation panels as used in container construction, the production of automotive roof liner constructions made of a thermoplastic polyurethane foam, a chopped strand mat and a decorative fabric, the NCO prepolymer bonding the layers to one another but also in addition reinforcing the total composite, or also the strengthening of loose stone formations in road construction. Preferred NCO ranges for this market segment are NCO contents of approx. 12 to 18 wt. %.

NCO-terminated prepolymers with NCO contents of approx. 6 to 12 wt. % produce more flexible polyurethanes after curing and are therefore suitable for the production of more flexible composite materials, such as for example the production of rubber granulate compounds as flooring panels for children's playgrounds.

Even more flexible polyurethanes are obtained with isocyanate terminated prepolymers with isocyanate contents of 1 to 5 wt. % which are widely used as construction sealants or as adhesive sealants in the automotive industry for bonding windscreens etc.

A new class of polyurethane adhesives are the reactive polyurethane hotmelts which at isocyanate contents of 2 to 5 wt. %, depending on the polyol used, can also lead to very rigid polyurethane.

It is common to all these prepolymers that the reaction of water with isocyanate groups with chain extension leads to polyurea segments which give the polyurethanes obtained a high strength with outstanding physical properties (such as toughness, thermostability etc).

The substantial advantage of the prepolymers is that they are one-component systems because the reaction with water proceeds very safely and does not require any costly stoichiometric considerations as are required with two-component systems. The reaction always leads, even with a large excess of water, to a cured polyurethane. Normally the atmospheric moisture and/or substrate moisture present is sufficient as reaction partner, but it can also, particularly with dense top coats such as for example aluminium profiles, be sprayed with water.

For practical use, the open time of the systems is adjusted by adding catalysts. By open time is understood the time in which the systems are still readily processable after application to the substrates to be bonded. The term “processable” should be redefined for each use. With adhesives, the processability is in general defined by the time when two substrates can still be joined without problem. If the processing time is exceeded, the optimum properties such as for example a repositioning, are no longer achievable.

The time that is necessary from the end of the processing time to achieving the optimum end properties should be as short as possible because excessively long waiting times in practice mean higher and higher costs, such as for example longer dwell times in the press, etc.

The length of the processing time can in practice be controlled as required by using catalysts in principle, but at the same time the storability of the systems (without water entry) is also negatively affected by all catalysts so that very rapidly adjusted systems also have a limited storability, which affects the logistics of the products. The limited storability is shown principally in a sharp rise in viscosity which can result in gelation. On the other hand, some catalysts in fact allow good control of the processing time, but produce an excessively long cure time of the systems. This means as a rule that the parts have to be stored temporarily before they can be further processed.

An overview of catalysts can be found for example in A. Farkas and G. A. Mills, Adva. Catalysis, 13, 393 (1962), J. H. Saunders and K. C. Frisch, Polyurethanes, Part I, Wiey-Interscience, New York, 1962, Chap. VI, K. C. Frisch and L. P. Rumao, J. Macromol. Sci.-Revs. Macromol. Chem., C5 (1), 103-150 (1970), or G. Woods, The ICI Polyurethane Book, John Wiley & Sons, pp 41-45, 1987.

Common catalysts are the products known in polyurethane chemistry, such as tert. aliphatic amines and/or metal catalysts.

Thus metal catalysts such as for example dibutyl tin dilaurate show an outstanding acceleration of the water reaction with prepolymers containing isocyanate groups also associated with good through-hardening, but the storability is also negatively affected to the same extent. An improvement is in fact achieved in EP-A 0 132 675 by the “blocking” of the catalyst by addition of tosyl isocyanate, but the slightest traces of moisture are enough to cancel this blocking, which overall results in an improved but still insufficient storability.

Mostly in practice a mixture of various catalysts is used to as far as possible achieve the combination of all properties.

A general disadvantage of the prepolymers based on aromatic polyisocyanates is the tendency of the end products to a strong discolouration under the effect of light which is prohibitive for many applications. A generally recognised principle for eliminating this disadvantage is the use of suitable additives, such as for example combinations of sterically hindered phenols and sterically hindered aliphatic amines (“HALS types”) which however only produce a gradual improvement. A fundamental improvement is the use of aliphatic polyisocyanates, such as for example hexamethylene diisocyanate, isophorone diisocyanate or 4,4′-diisocyanato-dicyclohexyl methane in the form of its steric isomer mixtures or the above diisocyanates in the form of their derivatives.

With these polyisocyanates, however, it is shown that in contrast to the aromatic polyisocyanates the reaction with water only proceeds very sluggishly.

Very high concentrations of metal catalysts, such as for example dibutyl tin dilaurate or bismuth salts, are required to catalyse the reaction at all. Catalyst concentrations at this level however always act negatively on the long-term functional properties, such as for example the hydrolysis resistance of for example polyester based adhesives. The tert. aliphatic amines very common with adhesives based on aromatic polyisocyanates as catalysts, such as for example 1,4-diazabicyclooctane or dimorpholinodiethylether, likewise prove to have low catalytic activity, cf L. Havenith in Paint Manufacture, December 1968, pp 33-38, in particular page 34.

Also discussed in the literature are technically very costly processes in which the systems to be hardened, principally coatings in thin layer, are hardened in chambers with moisture in the presence of highly volatile tert. aliphatic amines, such as for example trimethylamine, and possibly elevated temperature. Since very high catalyst concentrations can be used by this procedure without them remaining in the product, the problems described above do not occur.

Catalysts which with good control of the processing time only impair the storability of the systems to a slight extent and at the same time enable rapid through-hardening, are therefore sought.

### SUMMARY OF THE INVENTION

The subject matter of the present invention are therefore adhesives and/or sealants based on prepolymers containing isocyanate groups on the basis of aliphatic polyisocyanates with isocyanate contents of 1 to 20 wt. %, characterised in that bis(dimethylaminoethyl)ether is used as catalyst singly or in addition to other catalysts.

Bis(dimethylaminoethyl)ether surprisingly shows as catalyst a balanced ratio of processing time to through-hardening time with a very slight effect on the thermostability of the isocyanate group terminated prepolymers based on aliphatic polyisocyanates. The catalyst has been described in the literature (DABCO BL-11, made by Air Products; JEFFCAT ZF 20, made by Huntsman) as a good catalyst with particular acceleration of the foam reaction (blow catalyst). An indication of its efficiency in connection with adhesives and sealants is not described.

### DETAILED DESCRIPTION OF THE INVENTION

As used herein in the specification and claims, including as used in the examples and unless otherwise expressly specified, all numbers may be read as if prefaced by the word “about”, even if the term does not expressly appear. Also, any numerical range recited herein is intended to include all sub-ranges subsumed therein.

As NCO-terminated prepolymers with isocyanate contents of 1 to 20 wt. %, preferably 2 to 16 wt. %, are to be understood reaction products of aliphatic polyisocyanates with hydroxyl polyesters and/or hydroxyl polyethers which cure as such or formulated with plasticisers, fillers, rheology aids by the reaction with atmospheric moisture and/or substrate moisture to high-molecular polyurethane polyureas.

Of the possible aliphatic polyisocyanates are to be understood in particular hexamethylene diisocyanate, isophorone diisocyanate and 4,4′-diisocyanato-dicyclohexylmethane in the form of its steric isomer mixtures. Included therewith are of course also the use or incorporation of the afore-mentioned diisocyanates in the form of their derivatives, such as for example biurets, allophanes, uretdiones and trimers and mixed forms of these derivatisations.

The hydroxyl polyesters include reaction products of aliphatic dicarboxylic acids, such as for example adipic, azelaic, sebacic and/or dodecanoic diacid and/or aromatic dicarboxylic acid, such as ortho, iso or terephthalic acid with glycols of the type ethylene glycol, diethylene glycol, 1,2-propylene glycol, 1,4-butanediol, neopentyl glycol or 1,6-hexanediol and/or triols such as for example glycerol or trimethylol propane. The reaction is a normal melt condensation as described in Ullmanns Enzyklopadie der technischen Chemie, “Polyester”, 4^{th} edition, Verlag Chemie, Weinheim, 1980. The result, depending on the composition, are liquid grades, amorphous grades with glass transition temperatures of >20° C. or crystalline polyester polyols with melt ranges of 40-90° C. The molecular weight range of 200 to 30000. The molecular range of 400 to 5000 is particularly preferred.

Appropriate hydroxyl group-terminated poly-ε-caprolactone and/or hydroxyl group-terminated polyesters of carbon dioxide such as for example hexanediol-1,6-polycarbonate or mixtures of carbon dioxide and ε-hydroxycarboxylic acid can also be used.

To be named here are also in particular the products which are derived from reaction products of glycerol and hydroxyl fatty acids, in particular castor oil and its derivatives, such as for example singly dehydrated castor oil.

Of the polyether polyols are to be named in particular those normally by base-catalysed addition of propylene oxide and/or ethylene oxide to starting molecules, such as for example water, 1,2-propanediol, 2,2-bis(4-hydroxyphenyl)propane, glycerol, trimethylolpropane, ammonia, methylamine or ethylene diamine with molecular weights of 200 to 6000, in particular 200 to 5000. In particular, the polypropylene ether polyols are also those which can be obtained by double metal catalysts and enable the synthesis of very high-molecular well-defined polyether polyols with molecular weights of up to 25000. The polyether polyols with therein dispersed organic fillers, such as for example addition products of tolyulene diisocyanate with hydrazine hydrate or copolymers of styrene and acrylonitrile, are of course also possible.

The polytetramethylene ether glycols, obtainable by polymerisation of tetrahydrofuran, with molecular weights of 400 to 4000 but also polybutadienes containing hydroxyl groups can also be used.

Mixtures of the mentioned polyols in mixture with low-molecular polyols such as for example ethylene glycol, butanediol, diethylene glycol or 1,4-butanediol can of course also be used.

The afore-mentioned polyols can of course be reacted with all polyisocyanates, aromatic and also aliphatic, before the actual prepolymerisation to urethane modified hydroxyl compounds.

The production of the isocyanate-terminated prepolymers takes place in accordance with known methods by causing the polyols to react with a stoichiometric excess of aliphatic polyisocyanates at temperatures of 30 to 150° C., preferably 60 to 140° C. This can take place discontinuously in vessels or continuously in vessel cascades or via mixers.

It is particularly preferred that the hydroxyl compounds are reacted with a high excess of diisocyanates and that the monomer diisocyanate still present is extracted from the prepolymer according to known techniques, such as for example via a thin layer evaporator at elevated temperature and reduced pressure. In this way, prepolymers with a low monomer content which depending on the residual monomer content are no longer subject to labelling, are obtained.

Modified aliphatic polyisocyanates can be added to all these products before, during or preferably after the reaction to fine control the properties. Such products are commercially available, such as for example under the names Desmodur® N 100 (HDI biuret modification) or Desmodur® N 3300 (HDI trimerisation) of Bayer AG or Vestanat® (IPDI trimer).

According to the end viscosity to be expected which depending on the formulation can vary between low viscosity to high viscosity, various aggregates are possible.

The catalyst bis(dimethylaminoethyl)ether is added to the prepolymers before, during or preferably after the end of prepolymer formation.

The quantity of this catalyst added depends on the desired processing time. As a rule, quantities of 0.02 to 3.0 wt. %, preferably 0.1 to 2.0 wt. %, particularly preferably 0.5 to 1.5 wt. %, based on the prepolymer, are sufficient.

In addition, solvents, fillers, colorants and rheology aids as known in practice can be added to the prepolymers.

Chalk, barytes, and also fibrous fillers such as polyamide fibres or polyacrylonitrile fibres may be mentioned as fillers. Among the rheology aids, in addition to the common industrial additives such as aerosils, bentonites or hydrated castor oil, can also be named lower-molecular amines which in combination with polyisocyanates very quickly form a pseudoplasticity. With all these additives it must be ensured that moisture is excluded absolutely because this would cause a premature reaction in the container.

Application of the adhesives and sealants takes place for example by knife application, spraying, brush application or even in more compact form in the form of a bead.

A good method for assessing the different curing phases of such systems is possible for example using commercial equipment such as for example Drying Recorder BK 10 (The Mickle Laboratory Engineering Co. Ltd) which is widely used in the coatings, adhesives and sealants industry. A needle if necessary loaded with a weight is passed at constant speed through a thin film of the prepolymer to be assessed on a support (e.g. glass plate). Three phases which according to the definition are designated by the terms “processing time” and “through-hardening time” are observed.

At first the needle runs through the liquid film and the track of the needle disappears more or less completely, which is to be correlated with the processing time. The end of the processing time, also termed skinning time, open time or contact tack time, is indicated by the first appearance of a permanent track of the needle.

There then follows a fairly long section (corresponding to time passed) in which the needle leaves a track. When the film is sufficiently through-hardened, the needle is no longer able to penetrate the polymer film, the needle runs track-free over the polymer film which is to be designated in measurement terms through-hardening time. The beginning of this state is connected in measurement terms of course in addition to the general composition of the adhesive to the weight with which the needle is loaded and cannot therefore be synonymous with the time in which the polymer reaches its end properties. The time however correlates very well with terms such as for example reaching the “manual strength”, “folding strength”, etc.

The practitioner wants the time between the end of the processing time and achieving the through-hardening time to be as short as possible.

Shortening this time with as far as possible any processing time and as far as possible unimpaired storability of NCO-terminated prepolymers is the subject matter of the invention.

The subject matter of the invention is also the use of thus catalysed prepolymers as adhesives and/or sealants in which curing of the aliphatic isocyanate groups takes place with moisture. Possible applications inter alia are the bonding of wood specimens, such as for example dovetail joints, wooden boards or beams. Likewise, bonding wood shavings, woodchips or wood flour into sheets or shaped bodies is possible. In these applications, prepolymers with isocyanate contents of approx. 10 to 20% are particularly suitable. Lower isocyanate contents are more suitable for low-module polymers, such as for example for the use of non-discolouring light joint sealants or for the range of reactive polyurethane hotmelts in which such a prepolymer is applied at temperatures of over 80° C. and on cooling builds strength on the basis of physical processes and the end reaction takes place with moisture (cf EP-A 0 354 527).

The following examples should explain the invention.

### EXAMPLES

### Experimental Part:

### Example 1

### Prepolymer Production (HDI)

1000 g (4.587 mol) polypropylene glycol with a hydroxyl value of 515 mg KOH/g and 3850 g (22.94 mol) hexamethylene diisocyanate are reacted at approx. 80 to 90° C.

The prepolymer shows at the end of the reaction time of 6 hours a constant NCO value of 31.5%. The prepolymer is then largely freed of excess monomers at 160° C. and 0.1 mm Hg using a short path evaporator.

A medium-viscosity prepolymer with an isocyanate content of 12.5% and a viscosity of 4500 mPas at 23° C. is obtained. The residual monomer content is 0.35%.

### Example 2

### Prepolymer Production (IPDI)

1000 g (1.0 mol) polyester polyol based on diethylene glycol and adipic acid with a hydroxyl value of 112 mg KOH/g and an acid number of 10.9 mg KOH/g and 888 g (4.0 mol) isophorone diisocyanate are reacted at approx. 100° C.

The prepolymer shows at the end of the reaction time of 9 hours a constant NCO value of 13.2%. The prepolymer is then largely freed of excess monomers at 180° C. and 0.1 mm Hg using a short path evaporator.

A high-viscosity prepolymer with an isocyanate content of 5.8% and a viscosity of 6000 mPas at 50° C. is obtained. The residual monomer content is 0.25%.

### Example 3

### Examination on the Drying Recorder (Test Description)

Using a doctor blade (250 μm), a film is applied to a glass plate previously cleaned with ethyl acetate and immediately placed in the drying recorder. The needle is loaded with 10 g and moves over a period of 360 minutes over a 35 cm section.

The drying recorder is situated in a climatic chamber at 23° C. and 50% relative humidity.

100 g of the prepolymer from Example 1 are mixed with various commercially available catalysts such that a processing time (visible appearance of a permanent track of the needle in the film) of approx. 25 to 60 minutes is produced with the drying recorder.

The through-hardening time is given at the time the permanent track of the needle disappears from the film.

| | | | Viscosity | | Through- |
|---|---|---|---|---|---|
| | | | after 4 h | | hardening |
| | | | (mPas) at | Processing | time |
| Example 3 | Catalyst | Quantity (wt. %) | 23° C. | time (min) | (min) |
| A | None | | 4500 | >360 | >360 |
| B | N,N-dimethyl- | 1.2 | 5500 | 40 | 53 |
| | ethanolamine | | | | |
| C | Coscat 83 | 2.5 | 5000 | 58 | 107 |
| D | DABCO NE | 0.75 | 5500 | 39 | 54 |
| | 1060 | | | | |
| E | DABCO 33 LV | 4.5 | 8000 | 300 | >360 |
| F | DABCO | 2.0 | 4800 | 245 | 320 |
| | DMDEE | | | | |
| G | DBTL | 1.0 | 6000 | 160 | 318 |
| H | Bis(dimethylaminoethyl) | 0.5 | 4700 | 39 | 53 |
| | ether | | | | |
| I | Bis(dimethylaminoethyl) | 1.0 | 4900 | 24 | 36 |
| | ether | | | | |

| | |
|---|---|
| Legends: | |
| Coscat ® 83 | Neodecane acid bismuth(3+)salt (Versatic acid Bismuth(3+)salt) |
| DABCO NE 1060 | N-dimethylaminopropylurea |
| DABCO 33 LV | triethylenediamine 70% in dipropylene glycol |
| DABCO DMDEE | dimorpholinodiethylether |
| DBTL | dibutyl tin dilaurate |

As can be seen from the table, only with the amine catalysts (Example 3B, 3 C and 3H, or 3 I) at doses of 1 wt. % and less are greatly shortened processing times achieved with certainty.

### Example 4

Long-term storage tests were carried out at 60° C. in aluminium bottles with catalysts Example 3B, 3 C and 3H.

The NCO values, viscosity at 50° C. processing time were determined.

| | | | Viscosity | | |
|---|---|---|---|---|---|
| | | NCO content | (mPas) after | Processing | |
| | Recipe | (%) | days | time | Cure time |
| | from | after days | at 50° C. | after days | after days |
| Example | example | 0/7/14/28 | 0/7/14/28 | 7/14/28 | 7/14/28 |
| A | 0 value | 12.46/12.36/ | 500/540/570/ | >360 | >360 |
| | 3 A | 12.39/12.39 | 620 | | |
| B | 3 B | 11.61 | 600/gelled/ | 28/25/24 | 65/70/60 |
| | | | gelled | | |
| C | 3 C | 11.98/11.12 | 530/900 | 50/170 | >360 |
| D | 3 H | 12.09/11.13/ | 465/780/850/ | 52/40/45/ | 71/53/60/ |
| | | 11.12/11.09 | 930 | 45 | 61 |

Test 4 B was terminated prematurely due to lack of storage stability (gelation after 1 week).

Test 4 C was terminated prematurely due to lack of stability of the catalyst (increasing deactivation).

The advantages of the catalyst according to the invention bis(dimethylaminoethyl)ether are clear (Example 4D). A slight impairment of the storage stability compared with the uncatalysed prepolymer is observed, but the drop in the NCO value or rise in viscosity over a storage period of 112 days (4 weeks) at 60° C. is to be tolerated in view of the enormous acceleration in the water reaction.

### Example 5

561 g prepolymer from Example 1 was mixed with 339 g Desmodur® N 3300 from Bayer AG (trimer of hexamethylene diisocyanate with 21.8% NCO content and 0.1% free HDI monomer) and 100 g chalk (Omya Kreide). The result is an adhesive mixture with approx. 14.5% NCO content. The adhesive is tested with and without 0.45% wt. % bis(dimethylaminoethyl)ether as adhesive for beechwood test pieces (split-free).

The prepolymer was coated on one side and the test pieces (50×20×5 mm) for 10×20 mm overlapping kept in the press at 5 bar at 23° C. and 50% relative humidity. The adhesive strength is then measured using the tensile shear test (10 test pieces each).

The following results are obtained

| | | Adhesive | | Adhesive | |
|---|---|---|---|---|---|
| | | uncatalysed | | catalysed | |
| | | Tensile | | Tensile | |
| | | strength | Standard | strength | Standard |
| Test after | | (N/mm²) | deviation | (N/mm²) | deviation |
| 1 | h | — | | 7.9 | 1.2 |
| 2 | h | — | — | 9.2 | 1.9 |
| 3 | h | — | — | 10.2 | 1.2 |
| 4 | h | — | — | 11.6 | 0.8 |
| 5 | h | — | — | 9.3 | 0.6 |
| 6 | h | — | — | 9.0 | 0.4 |
| 24 | h | — | — | 9.2 | 0.6 |
| 48 | h | — | — | 8.0 | 2.5 |
| 72 | h | 7.2 | 0.7 | 9.5 | 0.6 |
| 7 | days | 11.8 | 0.9 | 9.6 | 1.5 |
| 14 | days | 12.0 | 0.9 | 9.6 | 1.1 |

The catalysed adhesives according to the invention give good composite strengths after a short period.

Parallel to this, 1 mm thick films on cardboard were exposed to intensive sunlight for 7 weeks.

For the uncatalysed film, a yellowness index (measured with the colour difference “Micro Color” measuring device of Dr. Lange, reference number LMG 051/052) of 5.5 and for the catalysed variant a yellowness index of 6.8 is observed.

Result: no drastic increase in colour as is occasionally observed with tert. aliphatic amine catalysts.

### Example 6

100 g of the prepolymer from Example 2 are mixed with various commercially available catalysts such that a processing time (visible appearance of a permanent track of the needle in the film) of approx. 25 to 60 minutes is produced with the drying recorder.

The through-hardening time is given at the time the permanent track of the needle disappears from the film.

| | | | | Through- |
|---|---|---|---|---|
| | | Quantity | Processing | hardening |
| Example 6 | Catalyst | (wt. %) | time (min) | time (min) |
| A | None | | >360 | >360 |
| B | N,N-dimethyl | 1.2 | 40 | 53 |
| | ethanolamine | | | |
| C | Coscat 83 | 2.5 | >350 | >350 |
| D | DABCO NE | 0.75 | 39 | 73 |
| | 1060 | | | |
| E | DABCO | 2.0 | >345 | >350 |
| | DMDEE | | | |
| F | DBTL | 1.5 | >350 | >350 |
| G | Bis(dimethylaminoethyl) | 0.5 | 84 | >350 |
| | ether | | | |
| H | Bis(dimethylaminoethyl) | 0.75 | 59 | 83 |
| | ether | | | |

Legends:

| | |
|---|---|
| Coscat ® 83 | Neodecane acid bismuth(3+)salt (Versatic acid |
| | Bismuth(3+)salt) |
| DABCO NE 1060 | N-dimethylaminopropylurea |
| DABCO DMDEE | dimorpholinodiethylether |
| DBTL | dibutyl tin dilaurate |

As can be deduced from the table, only with the amine catalysts (Examples 6D and 6 G, or 6H) at doses of 1 wt. % and less are greatly shortened processing times achieved with safety.

### Example 7

Storage stability tests at 60° C. are done in aluminium cartridges with the mixtures (zero sample Example 2; mixture Example 6D and Example 6H).

The NCO values, viscosity at 50° C. processing time were determined.

| | | | Viscosity | | |
|---|---|---|---|---|---|
| | | NCO | (mPas) at | | Through- |
| | | content | 50° C. after | Processing | hardening |
| | Recipe | (%) after | days | time after | time after |
| | from | days | 0/7/14/ | days 7/14/ | days |
| Example | example | 0/7/14/28 | 28 | 28 | 7/14/28 |
| A | 6A | 5.34/5.30/ | 5370/5590/ | >360 | >360 |
| | (0 value) | 5.27/5.26 | 5560/5800 | | |
| B | 6 B | 5.25/ | 6200/ | | |
| C | 6 D | 5.07/4.72/ | 5400/7600/ | 55/>350 | >360 |
| | | 4.66/4.62 | 8100/9300 | | |
| D | 6 H | 5.04/4.93/ | 5200/5600/ | 52/40/53/ | 105/95/ |
| | | 4.90/4.89 | 5600/5700 | 33 | 120/95 |

Test 7 B was terminated prematurely due to lack of storage stability (gelation after 1 week).

Test 7 C was terminated prematurely due to lack of stability of the catalyst (increasing deactivation).

The advantages of the catalyst according to the invention bis(diethylaminoethyl)ether are clear (Example 7D). A virtually identical storage stability compared to the zero sample is observed. The processing time can be drastically reduced.

### Example 8

4000 g of a hexanediol adipate (Baycoll® AD 5027 from Bayer AG) with a hydroxyl value of 28 mg KOH/g (1.0 mol) are dewatered at 120° C. for 60 minutes under vacuum. 399.6 g (1.8 mol) 3,5,5-trimethyl-3 isocyanatomethylene-cyclohexylisocyanate (Desmodur® I from Bayer AG) are added at 120° C.

After 60 minutes it is filled in cartridges and then post-cured at 100° C.

The storage stability is tested after 4, 24, 48 and 72 hours at 100° C.

### Example 8A

4000 g of a hexanediol adipate (Baycoll® AD 5027) with a hydroxyl value of 28 mg KOH/g (1.0 mol) are dewatered at 120° C. for 60 minutes under vacuum. 399.6 g (1.8 mol) 3,5,5-trimethyl-3 isocyanatomethylene-cyclohexylisocyanate (Desmodur® I from Bayer AG) are added at 120° C.

1.8 g (0.5 wt. %) bis(dimethylaminoethyl)ether are added after 60 minutes and homogenised.

After 30 minutes it is filled in cartridges and then post-cured at 100° C.

The storage stability is tested after 4, 24, 48 and 72 hours at 100° C.

| | Storage after | Storage after | Storage after | Storage after |
|---|---|---|---|---|
| | 4 h NCO | 24 h NCO | 48 h NCO | 72 h NCO |
| | value (%)/ | value (%)/ | value (%)/ | value (%)/ |
| | viscosity | viscosity | viscosity | viscosity |
| | (mPas) at | (mPas) at | (mPas) at | (mPas) at |
| Prepolymer | 100° C./130° C. | 100° C./130° C. | 100° C./130° C. | 100° C./130° C. |
| 8 | 1.56/10300/ | 1.50/12000/ | 1.45/13000/ | 1.40/14000/ |
| | 3500 | 3800 | 4000 | 4200 |
| 8 A | 1.28/14000/ | 1.30/14400/ | 1.26/15000/ | 1.24/16000/ |
| | 4400 | 4500 | 5000 | 5300 |

The cure characteristic is determined by means of the “folding test”. For this, a 0.1 mm thick prepolymer film is knife-applied to a glass plate, the solidified prepolymer subjected to a folding test after certain times (at 23° C. and 50 relative atmospheric humidity) by folding the polymer film 180°. Only a largely reacted polymer will survive the test. Unreacted polymers break because no sufficiently high molecular weight is constructed.

| Time after knife application | Prepolymer 8 | Prepolymer 8 A |
|---|---|---|
| 2 hours | Break | Break |
| 4 hours | Break | Break |
| 6 hours | Break | Folding resistance |
| 24 hours | Break | Folding resistance |
| 48 hours | Break | Folding resistance |
| 96 hours | Break | Folding resistance |

Again for the range of reactive polyurethane hotmelts, the catalyst according to the invention bis(dimethylaminoethyl)ether shows only insignificantly impaired storability compared with the uncatalysed system, with a significantly more rapid curing.

### Adhesion Tests

The adhesive heated to 130° C. is applied with a doctor blade to beechwood test pieces and bonded immediately with a PVC film

The strength is determined in the peel test.

| | Adhesive according to | Adhesive according to |
|---|---|---|
| Storage time of the test | Example 8 | Example 8A |
| piece in hours | Peel strength (N/mm) | Peel strength (N/mm) |
| 1 | 0.04 | 0.1 |
| 2 | 0.03 | 3.4 |
| 24 | 0.05 | 4.2 |
| 168 | 1.4 | 6.5 |
| 336 | 6.1 | 7.2 |

The adhesive heated to 130° C. is applied to beechwood test pieces on one side and bonded immediately with another beechwood test piece and torn in the tensile shear test.

| | Adhesive according to | Adhesive according to |
|---|---|---|
| Storage time of the | Example 8 | Example 8A |
| test piece in hours | Peel strength (N/mm2) | Peel strength (N/mm2) |
| 1 | 3.3 100% A | 5.4 90% A 10% K |
| 2 | 3.4 100% A | 7.7 10% F 50% A 40% K |
| 24 | 3.2 100% A | 10.7 20% F 80% A |
| 168 | 5.7 60% A 40% K | 10.8 40% F 60% A |
| 336 | 7.9 20% A 80% K | 11.0 30% F 70% A |

What is claimed is:

1. A moisture-curable adhesive or sealant composition comprising:
a) prepolymers which are the reaction products of aliphatic polyisocyanates and hydroxyl polyesters and/or hydroxyl polyethers and having isocyanate contents of 2 to 20 wt. %, and
b) bis(dimethylaminoethyl)ether as catalyst.

2. The composition according to claim 1, wherein the catalyst is used in a quantity of 0.02 to 3.0 wt. % based on the weight of the prepolymer.

3. The composition according to claim 1, wherein the catalyst is used in a quantity of 0.5 to 1.5 wt. % based on the prepolymer.

4. The composition according to claim 1, wherein the isocyanate group content is 3 to 17 wt. %.

5. The composition according to claim 1, wherein hexamethylene diisocyanate as monomer diisocyanate and/or in the form of its derivatives is used as aliphatic polyisocyanate.

6. The composition according to claim 1, wherein isophorone diisocyanate is used as isocyanate and/or in the form of its derivatives.

7. The composition according to claim 1, wherein the composition has a monomer diisocyanate content of less than 1.0%.

8. A polyurethane hotmelt system comprising the composition of claim 1.
